(19) United States
(12) Patent Application Publication
(10) Pub. No.: US 2008/0170713 A1
(43) Pub. Date: Jul. 17, 2008

(54) Audio Broadcast System For Elevator

(75) Inventor: Shinichi Nagata, Kanagawa-ken (JP)

Correspondence Address: FOLEY AND LARDNER LLP;SUITE 500, 3000 K STREET NW, WASHINGTON, DC, 20007, US

(73) Assignee: TOSHIBA ELEVATOR KABUSHIKI KAISHA

(21) Appl. No.: 11/817,432

(22) PCT Filed: Jan. 5, 2006
(86) PCT No.: PCT/JP2006/300030

§ 371 Date: Oct. 30, 2007

(30) Foreign Application Priority Data
Mar. 18, 2005 (JP) 2005-079782

(51) Int. Cl. B66B 3/00

(52) U.S. Cl. 381/77

(57) ABSTRACT

When an elevator passenger M1 gets on a cage 6, an audio broadcasting controller 2 in an elevator controlling device removes and outputs audio data of automatic audio guidance information from an audio data storage 3. The audio data is transmitted to a magnetic induction amplifier 10 as well as to an audio output 7. A loop antenna 11 then originates a radio wave which is received by a hearing aid 15 mounted on the elevator passenger M1.

### TECHNICAL FIELD

The present invention relates to an elevator audio broadcasting system.

### BACKGROUND ART

Elevators are in-building transportation means with a high public nature available to the general public and have been recently developed to provide comfortable usability to elderly persons or persons with disabilities. In some countries such as Japan, however, a so-called “Heartful Building Act” (in Japan) has been currently in effect for facilitating the utilization of comfortable buildings and their equipment for the passengers, especially elderly persons or persons with disabilities, and thus highly public elevator systems are also required to make certain considerations to these passengers.

For example, Japanese Patent Application Laid-Open No. 2002-362838 discloses an elevator system which broadcasts an elevator audio guidance with increased volume levels when it may identify an elevator passenger as a hearing-impaired person by passenger information received from a portable terminal carried by the elevator passenger. This trend for protecting the hearing-impaired persons is increasingly spreading not only in Japan but also in U.S.A., China, and so on.

### DISCLOSURE OF THE INVENTION

However, simply increasing the volume levels of broadcast audio will not necessarily allow persons with hearing loss to clearly hear the broadcast content, when they are in a noisy and disturbing environment. Increasing the volume levels will not also be a very effective measure if a person with hearing loss has a sensorineural hearing loss. Moreover, unnecessarily increased volume levels of broadcast audio will make an able-bodied person feel uncomfortable.

The present invention is provided in view of the above circumstances. An object of the present invention is to provide an elevator audio broadcast system which allows many persons with hearing loss using an elevator to clearly hear the broadcast content even in a noisy environment, while not making able-bodied persons feel uncomfortable.

To solve the above-mentioned problem, an elevator audio broadcast system according to a first aspect is characterized in that it includes an audio broadcasting controller for outputting audio data; an audio output for outputting audio to an elevator passenger based on the audio data from the audio broadcasting controller; and a loop antenna for converting and originating the audio data from the audio broadcasting controller into a radio wave capable of being received by an audio receiver mounted on an elevator passenger.

An elevator audio broadcasting system according to a second aspect is characterized in that, in the invention of the first aspect, the audio receiver is a hearing aid compliant with a magnetic loop system.

An elevator audio broadcasting system according to a third aspect is characterized in that, in the invention of the first aspect, the audio receiver is a headphone or earphone compliant with a magnetic loop system.

An elevator audio broadcast system according to a fourth aspect is characterized in that, in the invention of the first to third aspects, the loop antenna is disposed on at least one of the positions under the floor of a cage, above the ceiling thereof, within a wall thereof, or within a cage operation panel.

An elevator audio broadcasting system according to a fifth aspect is characterized in that, in the invention of any of the first to third aspects, the loop antenna is disposed on at least one of the positions under the floor of an elevator hall, above the ceiling thereof, within a wall around elevator doors, or within a hall operation panel.

An elevator audio broadcasting system according to a sixth aspect is characterized in that, in the invention of any of the first to fifth aspects, the audio broadcasting controller has a first control mode for outputting the audio data to both the audio output and the loop antenna; and a second control mode for outputting the audio data only to the loop antenna.

The present invention allows any person to clearly hear the broadcast content with an audio receiver capable of receiving a radio wave originated from a loop antenna. In addition, the present invention does not make any able-bodied persons without such receiver feel uncomfortable because the volume levels will not necessarily increase.

### BRIEF DESCRIPTION OF THE DRAWINGS

FIG. 1 is a block diagram of an embodiment of an elevator audio broadcasting system in accordance with the present invention;

FIG. 2 is a perspective view of the disposed positions of the loop antenna in the cage shown in FIG. 1; and

FIG. 3 is a perspective view of the disposed positions of the loop antenna in the elevator hall shown in FIG. 1.

### BEST MODE FOR CARRYING OUT THE INVENTION

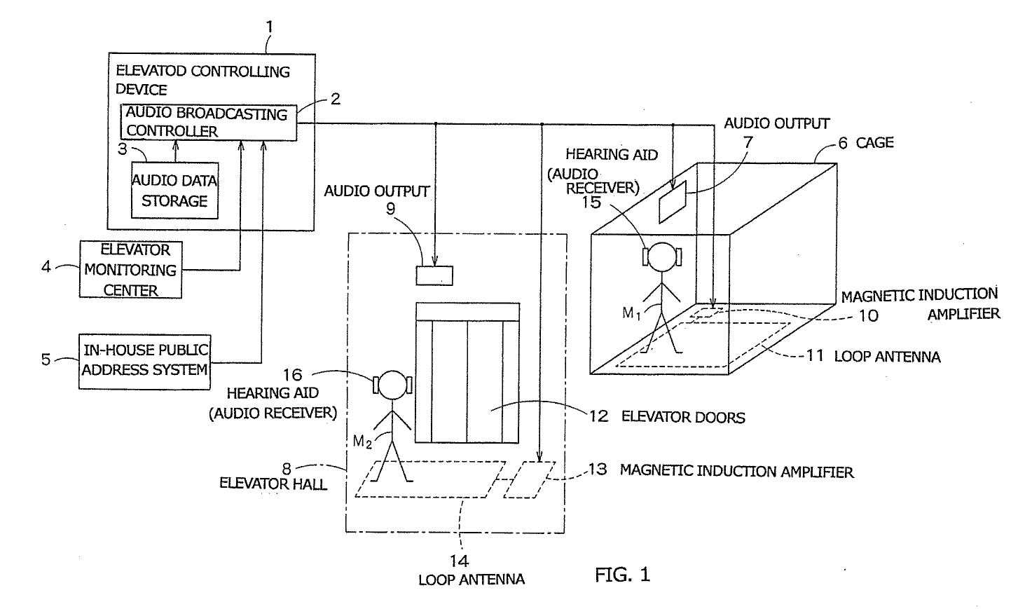

FIG. 1 illustrates a configuration of an embodiment of the present invention. The configuration shown in FIG. 1 employs a magnetic loop system. The magnetic loop system is a hearing aid support system often utilized in a hall or meeting room used by elderly persons recently and involves a magnetic induction amplifier originating, from a loop antenna as a radio wave, an audio signal provided by an audio output device such as a microphone. In this case, if a passenger with a hearing aid, e.g., an elderly person, is located inside or near the loop of the loop antenna, the hearing aid may receive a radio wave of clear audio. However, because the hearing aid must be compliant with a magnetic loop system, i.e., the one with a telephone coil, the passenger needs to turn a switch of the hearing aid to “T” or “MT” to set a mode compliant with the magnetic loop when he/she attempts to receive a radio wave from the loop antenna.

In FIG. 1, an elevator controlling device 1 has an audio broadcasting controller 2. The audio broadcasting controller 2 is adapted to remove and output audio data from an audio data storage 3, which data has been pre-recorded on the audio data storage 3 as automatic audio guidance information, or to remove and output audio data that is provided by the operators from an elevator monitoring center 4 or announced by an in-house public address system 5 and so on. The audio data output from the audio broadcasting controller 2 is then adapted to be sent and broadcast to an audio output (a speaker) 7 in a cage 6 and an audio output (a speaker) 9 in an elevator hall 8.

A magnetic loop system is constructed in the cage 6, and a magnetic induction amplifier 10 and a loop antenna 11 connected thereto are disposed under the floor of the cage 6. Another magnetic loop system is also constructed in the elevator hall 8, and a magnetic induction amplifier 13 and a loop antenna 14 connected thereto are disposed under the floor in front of elevator doors 12. The audio data output from the audio broadcasting controller 2 is then adapted to be sent to these magnetic induction amplifiers 10 and 13 as well as to the audio outputs 7 and 9 mentioned above. The magnetic amplifiers 10 and 13 are adapted to convert and originate the sent audio data into a radio wave with the loop antennas 11 and 14.

An elevator passenger M1 equipped with a hearing aid 15 as an audio receiver stands in a position inside the loop of the loop antenna 11 disposed in the cage 6. On the other hand, another elevator passenger M2 equipped with a hearing aid 16 as an audio receiver stands in a position inside the loop of the loop antenna 14 disposed in front of the elevator doors 12 in the elevator hall 8. Additionally, each of the hearing aids 15 and 16 mounted on the elevator passengers M1 and M2 has a telephone coil and is compliant with a magnetic loop system respectively. Thus, the elevator passengers M1 and M2 may receive the radio waves originated from the loop antennas 11 and 14 by turning the switches of the hearing aids 15 and 16 to “T” or “MT” to set a mode compliant with the magnetic loop.

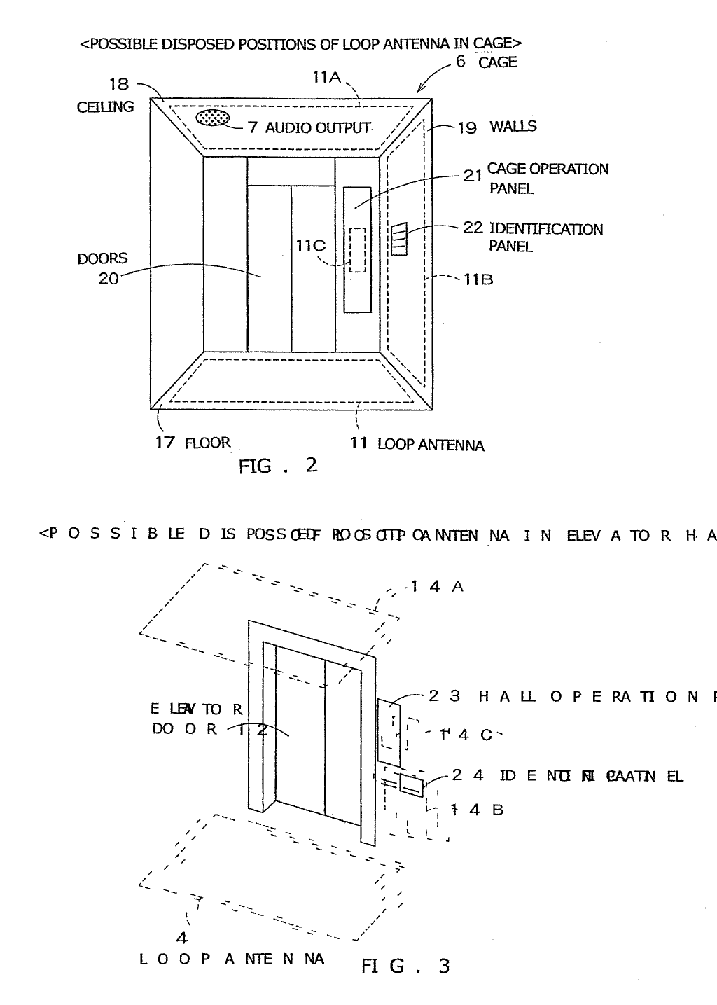

Although each disposed position of the loop antennas 11 and 14 shown in FIG. 1 is described in the context of those disposed under each floor of the cage 6 and the elevator hall 8 respectively, it is also possible to dispose these antennas in a location other than locations under the floor. The possible disposed positions will now be described based on FIGS. 2 and 3.

FIG. 2 illustrates a perspective view of the possible disposed positions of the loop antenna in the cage 6. The cage 6 has a floor 17, a ceiling 18, and walls 19, and a cage operation panel 21 is installed near a door 20. Additionally, a message for persons with hearing loss, e.g., elderly persons, is provided at a wall 19 nearer to the cage operation panel 21. That is, an identification plate 22 is attached to the wall 19 indicating that a magnetic loop system is constructed at the cage, and that clear broadcast audio may be heard by these persons by turning the switches of their hearing aids to “T” or “MT”.

Further, in addition to disposing the loop antenna 11 under the floor 17 as shown in FIG. 1, it is also possible to dispose a loop antenna 11A above the ceiling 18, a loop antenna 11B within the wall 19, and a loop antenna 11C within the cage operation panel 21. However, FIG. 2 indicates that one or more of the loop antennas 11, 11A, 11B and 11C can be selected as appropriate considering conditions such as elevator usage, and does not require all of the antennas to be disposed.

FIG. 3 illustrates a perspective view of the possible disposed positions of the loop antenna in the elevator hall 8. A hall operation panel 23 is disposed near an elevator door 12, and an identification panel 24, on which a similar message to the identification panel 22 mentioned earlier are provided, is attached below the hall operation panel 23.

Then, it is also possible to dispose the loop antenna 14 under the floor in front of the elevator doors 12 in a similar manner to that shown in FIG. 1, as well as to dispose a loop antenna 14A above the ceiling, a loop antenna 14B within a wall around the elevator doors 12, and a loop antenna 14C within the hall operation panel 23. This FIG. 3 also indicates as FIG. 2 that one or more of the loop antennas 14, 14A, 14B and 14C can be selected as appropriate considering conditions such as elevator usage, and does not require all of the antennas to be disposed.

Regarding the operations of FIG. 1, there will now be described an exemplary case where the elevator passenger M1 gets on the cage 6. Assuming the elevator passenger M1 has just got on the cage 6, and then passenger detecting means (not shown) detects the existence of the elevator passenger M1 and transmits the detection signal to the elevator controlling device 1. In response, the audio broadcasting controller 2 in the elevator controlling device 1 removes and outputs audio data of automatic audio guidance information from the audio data storage 3. Additionally, at this time, the elevator passenger M1 turns the switch of the hearing aid 15 to “T” or “MT” to set a mode compliant with the magnetic loop.

The audio data relative to the automatic audio guidance information from the audio broadcasting controller 2 is transmitted to the magnetic induction amplifier 10 as well as the audio output 7. The magnetic induction amplifier 10 outputs a magnetic field signal to the loop antenna 11 based on the transmitted audio data. According to changes in the magnetic field at this time, a radio wave is originated from the loop antenna 11 and received by the hearing aid 15 mounted on the elevator passenger M1. Therefore, the elevator passenger M1 may hear automatic audio guidance information of clear audio via the hearing aid 15.

In addition, even if any other elevator passengers without a hearing aid exist in the cage 6 at this time, no uncomfortable feeling would be given to these passengers, since only the broadcast audio from the audio output 7 would merely be heard by these passengers at normal volume levels.

On the other hand, although the explanation has been made in the case of the elevator passengers M1 and M2 being hearing loss and the audio receiver being the hearing aids 15 and 16 in the examples mentioned above, the present invention also allows a headphone or earphone compliant with a magnetic loop system being worn by any able-bodied elevator passenger to receive a radio wave from a loop antenna.

In this case, the audio broadcasting controller 2 preferably has the following two control modes: a first control mode for providing both outputs to the audio outputs 7 and 9 and to the magnetic induction amplifiers 10 and 13 (i.e., the loop antennas 11 and 13); and a second control mode for providing outputs only to the magnetic induction amplifiers 10 and 13 (i.e., the loop antennas 11 and 13). Then, in the first control mode, the audio broadcasting controller 2 outputs information necessary for all of the elevator passengers such as elevator operation information, and, in the second mode, plays content such as light music or an in-house broadcasting from the in-house public address system 5.

In accordance with the first control mode mentioned above, both the elevator passengers with the headphone or earphone and without such headphone or earphone may hear the content of the audio data from the audio broadcasting controller 2. On the other hand, in accordance with the second control mode, only the elevator passengers with the headphone or earphone may hear the content of the audio data from the audio broadcasting controller 2.

Some elevator passengers, however, may not be willing to hear light music or in-house broadcasting, and thus the second control mode would be a more comfortable environment for these passengers. Therefore, the second control mode may provide for an environment that meets the needs of both the passengers mentioned above.

1. An elevator audio broadcasting system wherein the system comprises:
an audio broadcasting controller for outputting audio data;
an audio output for outputting audio to an elevator passenger based on the audio data from the audio broadcasting controller; and
a loop antenna for converting and originating the audio data from the audio broadcasting controller into a radio wave capable of being received by an audio receiver mounted on an elevator passenger.

2. The elevator audio broadcasting system according to claim 1, wherein the audio receiver is a hearing aid compliant with a magnetic loop system.

3. The elevator audio broadcasting system according to claim 1, wherein the audio receiver is a headphone or earphone compliant with a magnetic loop system.

4. The elevator audio broadcasting system according to claim 1, wherein the loop antenna is disposed on at least one of the positions under the floor of a cage, above the ceiling thereof, within a wall thereof, or within a cage operation panel.

5. The elevator audio broadcasting system according to claim 1, wherein the loop antenna is disposed on at least one of the positions under the floor of an elevator hall, above the ceiling thereof, within a wall around elevator doors, or within a hall operation panel.

6. The elevator audio broadcasting system according to claim 1, wherein the audio broadcasting controller has a first control mode for outputting the audio data to both the audio output and the loop antenna; and a second control mode for outputting the audio data only to the loop antenna.

7. The elevator audio broadcasting system according to claim 2, wherein the loop antenna is disposed on at least one of the positions under the floor of a cage, above the ceiling thereof, within a wall thereof, or within a cage operation panel.

8. The elevator audio broadcasting system according to claim 3, wherein the loop antenna is disposed on at least one of the positions under the floor of a cage, above the ceiling thereof, within a wall thereof, or within a cage operation panel.

9. The elevator audio broadcasting system according to claim 2, wherein the loop antenna is disposed on at least one of the positions under the floor of an elevator hall, above the ceiling thereof, within a wall around elevator doors, or within a hall operation panel.

10. The elevator audio broadcasting system according to claim 3, wherein the loop antenna is disposed on at least one of the positions under the floor of an elevator hall, above the ceiling thereof, within a wall around elevator doors, or within a hall operation panel.

11. The elevator audio broadcasting system according to claim 2, wherein the audio broadcasting controller has a first control mode for outputting the audio data to both the audio output and the loop antenna; and a second control mode for outputting the audio data only to the loop antenna.

12. The elevator audio broadcasting system according to claim 3, wherein the audio broadcasting controller has a first control mode for outputting the audio data to both the audio output and the loop antenna; and a second control mode for outputting the audio data only to the loop antenna.

13. The elevator audio broadcasting system according to claim 4, wherein the audio broadcasting controller has a first control mode for outputting the audio data to both the audio output and the loop antenna; and a second control mode for outputting the audio data only to the loop antenna.

14. The elevator audio broadcasting system according to claim 5, wherein the audio broadcasting controller has a first control mode for outputting the audio data to both the audio output and the loop antenna; and a second control mode for outputting the audio data only to the loop antenna.
